(19) United States
(12) Patent Application Publication
(10) Pub. No.: US 2009/0183698 A1
(43) Pub. Date: Jul. 23, 2009

(54) ELECTROMAGNETICALLY ACTUATED VALVE DEVICE

(75) Inventors: Jorg Burssner, Hufingen (DE); Michael Dennhardt, Stockach (DE)

Correspondence Address: BACHMAN & LAPOINTE, P.C., 900 CHAPEL STREET, SUITE 1201, NEW HAVEN, CT, 06510, US

(73) Assignee: ETO MAGNETIC GMBH, Stockach (DE)

(21) Appl. No.: 12/354,228

(22) Filed: Jan. 15, 2009

(30) Foreign Application Priority Data
Jan. 17, 2008 (DE) 10 2008 005 011.3

(51) Int. Cl. F16K 31/02; F01P 7/14

(52) U.S. Cl. 123/41.08; 251/129.07

(57) ABSTRACT

The invention relates to an electromagnetically actuated valve device with closure means (36) that can be actuated by an armature unit (32, 34) interacting with stationary coil means (22) which closure means are embodied for the controlled opening and/or closing of a flow region (18) formed between an inflow (12) and an outflow (14) in a valve housing (10, 16, 20), wherein the axially moveable armature unit (32, 34) embodied lengthwise comprises a passage which brings about pressure equalization so that in the valve housing on an axial end of the armature unit opposite to the inflow a pressure chamber (44) which is opened to the inflow via the passage is formed.

The present invention relates to an electromagnetically actuated valve device according to the preamble of the main claim.

A device of this type is generally known from the prior art and is for example frequently used in connection with the switching of cooling water circuits, for example in the automotive area. Specifically, as reaction to an electrification of the coil means according to the preamble the armature unit with closure means seated on the end side is actuated so that either as reaction to the electrification the valve opens and releases the cooling water flow (so-called de-energized closed (NC) application), or as reaction to the electrification a valve that is open in the state of rest, closes (so called de-energized open (NO) application).

From the prior art the armature unit (and thus the closure means seated thereon) are typically held in the respective rest position against the force of a resetting spring or the like; this is more preferably necessary for example when the force acting from a fluid flow on to the closure means has to be overcome.

If the valve is now to be actuated for opening or closing the resetting force exerted is to be always overcome initially so that in the electromagnetic configuration (thus for example in the size) a greater effort is required. In addition, the energy required for the armature movement to be brought about by means of the coil means is greater.

Before the background of limited installation spaces especially in motor vehicles, a desired reduction of the electric energy requirement and a general wear reduction with generic valve devices it is thus the object of the present invention to reduce a known valve device with respect to its force to be generated through the coil means or electromagnetically, furthermore to reduce the energy requirement for switching such a magnetic valve and generally realize the movement behavior of the armature unit and thus the switching behavior of the device with less force, more harmonically and thus with less wear.

The object is solved through the electromagnetically actuated valve device with the features of the main claim, furthermore the method for operating a valve device according to the Patent Claim 16 and the use of such a valve device according to the independent Patent Claim 17. Advantageous further developments of the invention are described in the subclaims.

In advantageous manner according to the invention the armature unit comprises a passage for bringing about pressure equalization in that on the opposite axial end of the armature unit a pressure chamber is formed. Through this it is advantageously achieved that the fluid pressure from the inflow acts evenly on both sides of the armature unit, so that through the electromagnet arrangement, more preferably the coil means and the corresponding, electromagnetically active units of the armature unit substantially less setting forces have to be generated. Advantageously this makes possible the far more compact design and similarly lower electric energy consumption for carrying out the setting operation of the armature unit.

In a particularly preferred manner the passage is embodied in form of a tube or tubular opening which runs axially along the armature unit so that in a constructively simple manner the pressure equalization can be established through the armature unit.

On the axial end facing away from the inflow the pressure chamber is additionally formed through a bushing-shaped armature guide tube which with this preferred embodiment of the invention makes possible the generating of the counterforce on the end of the armature unit facing away (preferably on the face end).

According to yet another further development the interaction of (according to a further development hollow-cylindrical) armature guide tube on the one hand and cylindrical armature body on the other hand can be used through the introduction of suitable seals provided radially or axially so that not only the pressure chamber is sealed at the edge side but that this seal in a suitably adjustable or predeterminable manner (e.g. through selection of suitable seal materials, for example PTFE) can also achieve movement damping of the armature movement. Through this in turn the dynamic characteristics of the device can be favorably influenced which for example is favorable for wear reduction and thus lifespan increase, additionally the noise development is reduced.

A further preferred embodiment of the invention provides that the passage in the armature unit according to the invention is preferably closed with a screen on the inflow side. A screen unit of this type can for example be easily fastened through overmolding with the plastic material used anyhow for the sealing element of the armature unit, in addition the screen element in an advantageous manner prevents the undesirable passing through of foreign materials of a dimension greater than the mesh size of the screen in the fluid to be switched in accordance with the valve.

In an advantageous manner according to the invention an opposite armature movement (i.e. which reduces the volume of the pressure chamber) in turn also results in clear-flushing of the screen unit namely in that the fluid contained in the pressure chamber can merely escape through the passage and thus backwards through the screen unit.

A further preferred further development of the invention, which can also be favorably combined with the versions or embodiments described above, provides that in the region of the passage the sealing element of the armature unit can be placed on both sides, i.e. on the inflow side and opposite to the inflow. This then makes possible that principally with the same drive mode of the armature unit either a valve can be realized which in the non-electrified state is in the permanent closure state (here, the sealing element would have to be typically arranged in a sealing manner on the inflow-side region of the passage), or in the non-electrified state is open (with arrangement of the sealing element on the outflow side, i.e. opposite to the inflow), wherein in this assembly state an activation or movement state of the armature unit achieved through electrification of the coil means brings the sealing element to the passage (more specifically: the opening which is described by the passage and adapted to the sealing element in a sealing manner) for closing.

This measure according to the invention thus makes it possible with maximum flexibility to alternatively assemble a respective valve device of the same design realization for two different operating modes, namely for a de-energized closed and a de-energized open operating mode of the armature unit.

It is also within the context of the present invention according to a further development to realize the valve housing of plastic (additionally preferably consisting of a plurality of housing parts), wherein the housing parts (housing sections) can then be suitably fitted together and possible dimensional tolerances can then be simply and reliably offset through sealing elements. In this manner the device according to the invention can be realized suitable for large series with minimum effort with very high reliability and operational safety.

In addition or as alternative to the damping of the armature movement presented above, other possibilities are also conceivable within the context of further developments which influence the movement or movement speed of the armature unit, for example through the targeted control (reduction) of an effective flow cross section in the passage (e.g. through a suitable orifice plate). Damping of the movement also has the advantageous effect that not only undesirable vibrations resulting in wear can be avoided but an armature movement deliberately slowed down through damping also has a positive effect on the noise behavior of the device.

While in addition the present invention is suitable in a particularly favorable manner for the cooling water circuit of a vehicle the range of the applications is principally unlimited.

The present invention specifically achieves as a result that in a surprisingly simple and constructively elegant manner an electromagnet valve device can be created which is clearly reduced in terms of the electromagnetic requirements, which combines low power consumption with advantageous, calculable and low-noise switching behavior with optimized manufacturability suitable for large series at the same time.

Further advantages, features and details of the invention are obtained from the following description of preferred exemplary embodiments and by means of the drawings; these show in:

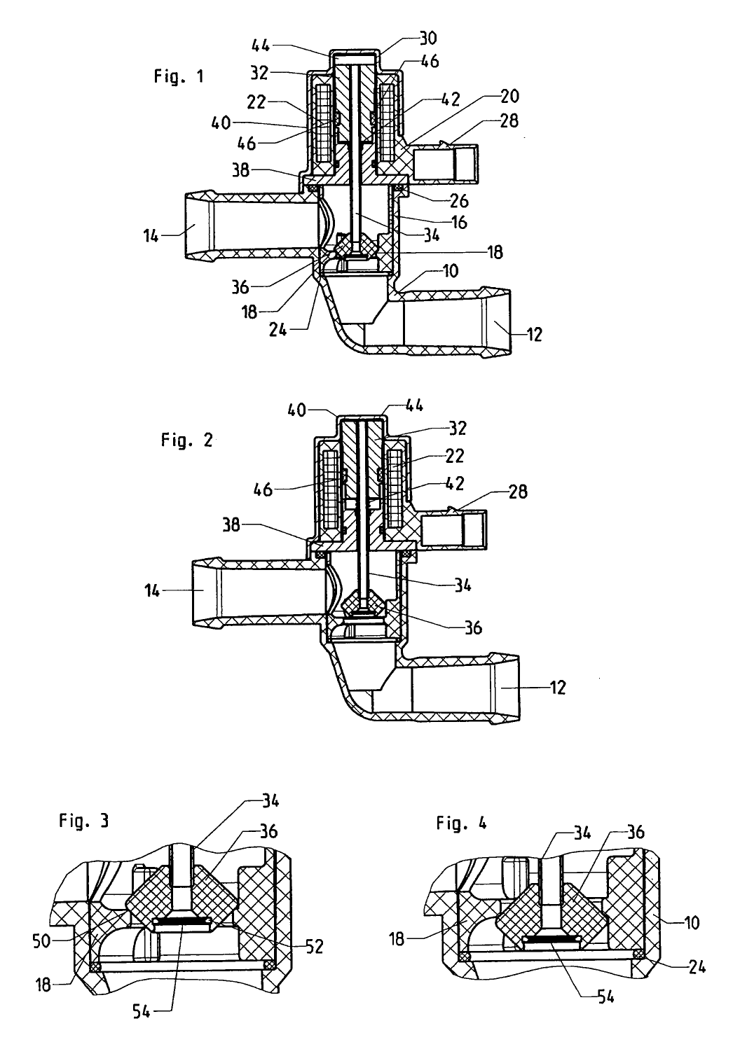

FIG. 1: a sectional view of the electromagnetically actuated valve device according to a first preferred embodiment of the invention in the electrified state of the coil means as so-called de-energized open application (i.e. valve closes upon electrification and activation of the armature unit);

FIG. 2: a view of the device according to FIG. 1, however with non-electrified coil means and thus opened flow state between inflow and outflow;

FIG. 3: a detail view of the valve seat region of FIG. 1, wherein it is clarified how the sealing element on the outflow side sits on the valve seat as passage, and

FIG. 4: a representation similar to FIG. 3, however in alternative assembly state such that the sealing element as closure means sits on the end side of the armature unit on the inflow-side region of the valve seat (passage), through which a de-energized-closed application (i.e. closure of the passage with non-electrified coil means) is realized, with otherwise same construction of the device as FIG. 1;

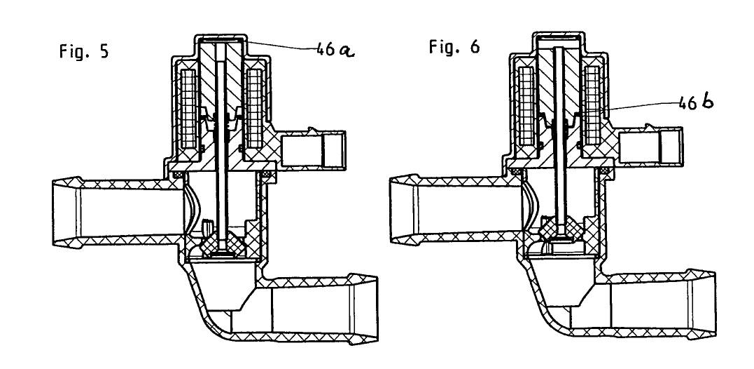

FIG. 5: a view similar to FIG. 1, however with sealing element arrangement according to FIG. 4, with a first version of an axial seal and

FIG. 6: a representation similar to FIG. 5, however assembly state according to FIG. 3, with a second version of an axial seal.

The figures show the exemplary embodiment of an electromagnetically actuated valve device used as magnetic valve for a cooling water circuit of a motor vehicle. Specifically, the complete valve device is realized module-like in a multi-part plastic housing 10 (with inflow 12 and outflow 14), 16 (for forming a valve seat 18) as passage for the cooling water) and 20 (for accommodating among other things stationary coil means 22) and constructed so that it can be easily manufactured suitable for large series. The housing parts (housing sections) 10, 16 and 20 in the sectional view shown in FIG. 1 are inserted into one another for realizing the total arrangement and, more preferably for the purpose of tolerance offsetting of dimensions, sealed against one another through ring seals 24, 26.

As shown in FIG. 1, 2 the upper housing section 20 comprises a connector section 28 seated thereon in one piece provided for electrical contacting and the hollow-cylindrical coil arrangement 22 on the inside contains a metal armature guide bushing 30 in the manner of a closed armature guide tube on the end side (in FIG. 1, 2 head side), in which an armature unit consisting of an armature body 32, an armature or valve rod 34 and a sealing body (sealing element) seated on the end side is guided in a sliding manner. More specifically, the armature body 32 in an otherwise known electromagnetic manner for the closing of a magnetic circuit interacts with a metal core section 38 (which forms a central opening for passing through of the valve rod) which closes the housing section 20 on the floor side, further with a metal magnetically conductive housing lid 40, so that upon electrification of the coil (coil means) 22 the armature unit is moved in axial direction (vertical direction of FIG. 1). As is additionally evident from FIG. 1, 2 the armature body 32 is preloaded in upward direction, i.e. against the closed end of the armature guide tube 30 by means of a compression spring 42 which supports itself against the stationary core 38, so that in the non-electrified state of the coil means the operating state explained in FIG. 2 materializes and the fluid (here: cooling water) can freely flow from the inflow 12 to the outflow 14 via the passage described by the valve seat 18.

It becomes clear however that even in the closure state of the sealing body 36 on the valve seat 18 the fluid which flows in through the inflow 12 is able to flow through the shown bore in the sealing element 36, the tubular hollow armature rod 34 and the upper, open end of the armature body 32 into a pressure equalization chamber (pressure chamber) 44, which in the manner shown in FIG. 1 is formed by the closed end of the bushing-like armature guide tube 30 upwards and to the side as well as through the upper face of the armature body 32.

The fluid thus flowing into the chamber 44 then brings about pressure equalization in such a manner that the pressure acting on the sealing element (and thus the armature unit) through the inflow can be neutralized through a backpressure (namely directed downwards on to the armature body 32) formed in the pressure chamber 44.

This then advantageously results in that clearly reduced electromagnetic setting forces are required in order for example to hold the armature in the closure position shown in FIG. 1 with the consequence that both dimensioning of the electromagnetic actuator (formed by the electromagnetically active components, more preferably coil means and armature body) can be dimensioned clearly smaller and far less control current for the setting movement or the holding operation is required so that the electric energy consumption of the device can also be drastically lowered.

Furthermore, FIG. 1, 2 advantageously show a sealing ring 46 (e.g. realized from PTFE or similar sealing material) which is held in a circumferential ring slot in the jacket of the armature body 32, which not only seals the sealing space 44 on the jacket side against the armature guide tube 30 but which additionally in a manner that can be established through its dimensioning achieves a rubbing and thus damping behavior of the armature body 32 against the stationary armature guide tube 30. In this manner the speed of the armature movement for example can be reduced and thus created more harmonically which does not only have an advantageous effect on the wear of the device but also on the noise behavior.

FIG. 3 in the detail view illustrates details of the interaction of the sealing element 36 with the stationary valve seat 18. It is evident that the sealing element 36 molded as plastic body to the end of a tube of the valve rod 34 in the shown closure state (electrified) sits on a circumferential ring shoulder 50 of the housing part 16 realizing the valve seat 18. In that both the valve seat 18 and also the sealing body 36 are formed of a plastic material, reliable sealing behavior of the valve can be realized.

The detail view of FIG. 3 additionally shows that a screen 54 held in a frame element 52 is so over molded by the plastic material of the sealing element 36 that the screen 34 closes the downward-directed opening of the tube 34. Thus it is ensured that foreign or solid bodies in the fluid are kept away from entering the tube 34 or the sealing space 44, while it is advantageously achieved at the same time that upon opening of the valve (i.e. moving of the armature device in the raised position of FIG. 2) through the concomitant volume reduction of the pressure chamber fluid contained therein flows downwards via the line 34 and thus back or clear flushing of the screen is achieved and clogging of said screen can be effectively prevented.

Positioned immediately opposite FIG. 3, FIG. 4 illustrates how—with otherwise identical construction—merely through assembly of the sealing element 36 on an inflow (i.e. in FIG. 4 lower) side of the passage (valve seat 18) a different operating mode can be realized: as is illustrated in FIG. 4 fluid flowing in through the inflow in the form shown would be effectively blocked, in other words the non-electrified position results in a closed valve. If however the armature unit is activated through the electrification of the coil means and moved downwards in axial direction, this results in an opening of the valve. The pressure equalization via the screen unit 54, the tube 34 and the pressure chamber 44 here allows a clear reduction of the necessary magnet forces with the advantages described above.

FIGS. 5 and 6 show further possible versions: FIG. 5 corresponds to the sectional representation of FIG. 1, 2 (with otherwise identical reference symbols), wherein according to FIG. 4 the sealing element is provided on the inflow side. As an alternative to the ring seal 46 (FIG. 1, FIG. 2) an axial seal 46a is provided on the face end relative to the armature body 32. A further version according to FIG. 6 shows an axial seal 46b with sealing element mounted on the outflow side between armature body 32 and core section 38.

1. An electromagnetically actuated valve device with closure means (36) that can be actuated through an armature unit (32, 34) interacting with stationary coil means (22), which closure means are formed for the controlled opening and/or closing of a flow region (18) formed between an inflow (12) and an outflow (14) in a valve housing (10, 16, 20), characterized in that the axially moveable armature unit (32, 34) embodied lengthwise comprises a passage which brings about pressure equalization such that in the valve housing on an axial end of the armature unit opposite to the inflow a pressure chamber (44) which is opened to the inflow via the passage is formed.

2. The device according to claim 1, characterized in that the closure means comprise screening means (52) which are so set up that a fluid flow flowing in from the direction of the inflow is subjected to filtration in the direction of the pressure chamber (44).

3. The device according to claim 1, characterized in that the closure means comprise a sealing element (36) which through overmolding of a screen element (52) with a plastic material is formed on the end side of a more preferably tubular valve rod (34) of the armature unit.

4. The device according to claim 1, characterized in that the armature unit comprises an armature body (32) as well as a lengthwise more preferably tubular valve rod (34) which on the end side comprises a sealing element (36) as closure means.

5. The device according to claim 4, characterized in that the cylindrically formed armature body (32) is guided in a hollow-cylindrical armature guide tube (30) closed bushing-like which with a face end of the armature body opposite to the inflow forms the volumetrically variable pressure chamber (44).

6. The device according to claim 5, characterized in that the armature body is sealed against the hollow-cylindrical region of the armature guide tube via radial (46) or axial (46a, 46b) sealing means.

7. The device according to claim 6, characterized in that the sealing means are realized, embodied and/or so embodied as ring seal held in a ring slot of the armature body so that the armature unit in its movement relative to the stationary armature guide tube is subjected to predetermined damping.

8. The device according to claim 1, characterized in that the armature unit is preloaded in the direction of the pressure chamber through the effect of a force storage unit (42), more preferably a compression spring.

9. The device according to claim 1, characterized in that a valve seat (18) provided in the flow region for the closure means having a sealing element (36) on the end side of a valve rod (34) of the armature unit is embodied so that the sealing element optionally as first assembly position (FIG. 4) in a side facing the inflow and as second assembly position (FIG. 3) on a side of the valve seat facing away from the inflow can be set up or assembled for the controlled opening and/or closing of said valve seat.

10. The device according to claim 9, characterized in that the armature unit, more preferably supported through spring action, is set up so that the valve device in the first assembly position with non-electrified coil means between inflow and outflow is closed.

11. The device according to claim 9, characterized in that the armature unit, more preferably supported through spring action, is set up so that the valve device in the second assembly position with non-electrified coil means between inflow and outflow is opened.

12. The device according to claim 1, characterized in that a valve seat (18) provided in the flow region for the closure means comprising a sealing element (36) on the end side of a valve rod (34) of the armature unit is realized from a plastic material, more preferably manufactured through an injection molding method and embodied for the sealing interaction with the sealing element realized of a plastic material.

13. The device according to claim 1, characterized in that the valve housing comprises a first housing section (10) forming the inflow and/or outflow and a second housing section (16) forming the flow region by means of a valve seat, wherein the first and the second housing sections are realized as separate plastic parts and can be assembled together via a seal (24) which brings about a tolerance offset.

14. The device according to claim 13, characterized in that the valve housing comprises a third housing section (20) realized of plastic for accommodating the coil means and a stationary armature guide tube enclosing the armature unit, wherein the third housing section is manufactured as separate plastic part and via a sealing element can be joined in a tolerance-offsetting manner with the first and/or second housing part for forming the valve housing.

15. The device according to claim 1, characterized by means for damping of the movement of the armature unit, more preferably through predetermined dimensioning of a flow-effective diameter of the passage.

16. The method for operating the valve device according to claim 1, characterized in that the passage carries a fluid which flows into the inflow to be switched by means of the valve device in such a manner that with closed flow region, foreign bodies in the fluid are held back by a screen unit (52) of the closure means and upon a movement of the armature unit a counterflow which brings about clear-flushing of the screen unit is brought about.

17. A use of an electromagnetically actuated valve device according to claim 1 for the switching of the cooling water flow for an internal combustion engine, more preferably in a motor vehicle.
